(19) United States
(12) Patent Application Publication
(10) Pub. No.: US 2002/0026403 A1
(43) Pub. Date: Feb. 28, 2002

(54) Systems and methods for facilitating transactions in a commodity marketplace

(76) Inventors: Roger Tambay, Rosemere (CA); Anthony R. Lettich, Johnson City, TN (US); James K. Caldwell, Piney Flats, TN (US); Sean A. Bowen, Marietta, GA (US)

Correspondence Address: Charles W. Calkins, Kilpatrick Stockton LLP, 1001 West Fourth Street, Winston-Salem, NC, 27282, US

(21) Appl. No.: 09/829,529

(22) Filed: Apr. 10, 2001

Related U.S. Application Data
(60) Provisional application No. 60/195,778, filed on Apr. 10, 2000.
(60) Provisional application No. 60/202,752, filed on May 8, 2000.

(51) Int. Cl. G06F 17/60

(52) U.S. Cl. 705/37

(57) ABSTRACT

The present invention relates to systems and methods for conducting a liquid exchange in a commodity goods marketplace and thereby creating an associated derivatives market. The commodity goods marketplace is implemented as a product trading center in which standardized products in a specific market segment are traded using standardized contracts. Various embodiments of the present invention may also comprise additional means of conducting product transactions and additional ancillary services supporting those transactions. An embodiment of the present invention provides computer network based systems and methods for conducting and facilitating transactions in the commodity polymer marketplace to further produce a derivatives market. The systems and methods of the present invention may be advantageously implemented as a business to business (“B2B”) e-commerce site on the world wide web.

### RELATED PATENT APPLICATION

This application claims priority under 35 USC 119 to, and incorporates by reference, U.S. Provisional Patent Application Serial No. 60/195,778, entitled “Systems and Methods for Facilitating Transactions in A Commodity Marketplace,” filed on Apr. 10, 2000 and U.S. Provisional Patent Application Serial No. 60/202,752, entitled “Systems and Methods for Facilitating Transactions in A Commodity Marketplace,” filed on May 8, 2000.

### FIELD OF THE INVENTION

The present invention relates to systems and methods for producing a derivatives market in a commodity goods marketplace. An embodiment of the present invention provides computer network based systems and methods for conducting and facilitating transactions in the commodity polymer marketplace to produce a derivatives market. The systems and methods of the present invention may be advantageously implemented as a business-to-business (“B2B”) e-commerce site on the World Wide Web.

### BACKGROUND

The terminology “commodity goods” is generally used to refer to goods, including manufactured goods, supplies, chemicals, parts and the like that are sold in large quantities, generally at low unit prices. For example, in the chemical industry, certain polymers, which are widely utilized by manufacturers, are considered commodity goods. Examples of such commodity polymers include, but are not limited to, PET (polyethylene terephthalate), polypropylene, EVA (ethylene vinyl acetate), PVC (polyvinyl chloride), polyethylene, and similar polymers that are sold in bulk at low unit (e.g. per lb.) prices.

The overall plastics commodities business are a 300 billion pounds global, highly cyclical industry wherein the largest producers who also have low overall delivered cost are able to achieve above cost of capital economics. Because of this, a significant amount of consolidation has occurred in the marketplace. Current examples include Hunstman acquiring Rexene, Amoco/BP merger, Exxon/Mobil merger, Shell/BASF/Montell venture, Dow/UCC, Lyondell/Quantum/Occidental (Equistar) and others. Through consolidation, producers expect to reduce overall costs, increase production efficiencies and develop a sustainable competitive advantage.

Currently, many commodity goods industries, including the plastics commodity market, face myriad problems, resulting in inefficiency in the marketplace and difficulty or inability to acquire risk management instruments. The markets are inefficient due to 1) the high cyclicality present in the markets, 2) the complex relationships present between the participants in the markets, and 3) a general lack of information on the part of the market participants. This lack of information concerns all aspects of the market, including product availability and quality, available trading partners, and current pricing information. The lack of pricing information stems from the lack of a credible and trusted price reference. Inefficiency and complexity lead to a further problem, the difficulty and high cost of acquiring risk management instruments in the plastics and other commodity markets. This problem is further exacerbated by the lack of liquidity in the market (Liquidity is defined as the speed, ease and convenience at which products can be converted into money without significant loss of capital).

The plastics commodity industry is highly cyclical. High industry cyclicality is due, at least in part, to high supply shortages leading to periods of high margin, followed by industry capacity build-up, that leads to periods of gross oversupply until demand picks up to meet supply. This inability to maintain a state of relative equilibrium is due in part to the complexity of the relationships between the participants in the industry.

FIG. 1 provides a schematic illustration of the current commodity polymer industry, including examples of players in the industry. The arrows illustrate material and goods flow among the players. For example, in current industry, the producer of Commodity Polymers 140 may receive Feed Stocks 120, Additives 110, and materials from Compounders 130 and send polymers to Convertors 160 and Brokers 150. The Convertors 160 may further send products to either directly to Brand Owners 170 or to Distributors 180 who then in turn may send the products to the Brand Owners 170. As shown by the multiple pathways in FIG. 1, this complex materials flow may contribute to the market inefficiencies discussed above.

Another problem facing many commodity goods industries, for example the industry for commodity polymers, is the lack of a credible and trusted price reference. The result of this is the excessive premiums associated with risk management instruments. Currently available price reports, for example Chemdata or TownsendTarnell, are particularly poor indicators of market pricing. Some of the problems of currently published pricing reports are as follows: a full 15-day lag time exists between effective date of prices and the date of publication; the lag time may extend to as many as 45 days, depending on when the time consideration begins, e.g., March 1st pricing may not be available until April 15th; the pricing is reported by participants through paper surveys over a 2-week period; the references are opinion-based, resulting in the opportunity to misrepresent the actual price paid; the participants use no common approach for the treatment of rebates or special incentives; the participants use no common approach for reporting changes in pricing between prices paid on day 1 of the survey process vs. day 10 of the survey process.

The foregoing complexity and lack of information cause inefficiency problems to occur in various markets, including short markets, long markets, and normal markets. A short market is one in which demand exceeds supply. Conversely, a long market is one in which supply exceeds demand. A normal market is a market in which demand and supply are essentially at equilibrium. In a short market, market inefficiencies may include the following for sellers and/or suppliers of commodities: a seller may have a compressed window of time to increase margins due to a lag time in industry perception in product tightness coupled with an anticipated and rapid supplier fear of product oversupply; a seller may be unable to determine the true value of a product in the marketplace; a seller may be limited to a maximum of one price increase per month at an “industry accepted” price increase increment (i.e. 3 to 5 cents/lb). For some segments where quarterly price protection is the norm, this problem is even more acute; and a seller may spend time and effort producing a specialized product to meet customer expectations rather than producing a standardized product that can be sold to customers willing to pay the market price.

Market inefficiencies, including the following, may also exist for buyers in a short market: a buyer may have to spend a disadvantageous amount of time sourcing product due to lack of product availability; a buyer would generally prefer access to prime material at higher than contract price directly from producers rather than from resellers, which leads to variable quality because of occasional reseller product quality misrepresentation; and a buyer may have difficulty in assessing the true marketplace dynamics due to lack of supplier credibility.

In a long market, market inefficiencies may include the following for sellers and/or suppliers of commodities: a seller may lack the ability to increase prices based on increases in raw material or feedstock price increases; a seller may have to spend a disadvantageous amount of time finding buyers for products; a seller may have difficulty assessing the true market dynamics at any point in time for output adjustment; a seller may have to guess at customer demand due to expected very short lead times from customers resulting in high inventory levels and occasional fire sales; and a seller may have a poor ability to identify customers with financial problems due to the lack of systematic customer payment information and further complicated by the need to expeditiously make sales.

Market inefficiencies, including the following, may also exist for buyers in a long market: a buyer may have difficulty in assessing true market price and therefore have difficulty in costing/pricing finished goods or inventory building in anticipation of turnaround; buyer confusion in quality of wide-spec offering from resellers may occur, leading to lack of processor discipline as some use wide-spec rather than prime materials to produce prime quality finished goods or ad hoc upgrading from resellers based on certificate of analysis (c.o.a.) information rather than supplier stated reason for downgrade (c.o.a.'s typically do not provide the detail of why a lot was downgraded and this is usually done verbally by the supplier); and a buyer may be unable to take advantage of true market pricing because the buyer is locked into procurement contracts with volume rebate incentives, limiting sourcing flexibility.

Market inefficiencies, including the following, may also exist in short, long and normal markets for sellers/suppliers: quality vendors may be unable to systematically recognize higher selling prices due to higher quality or real time performance because of customer information inefficiency and supplier inability to truly value price polymers; a seller may have difficulty in developing new business in new strategic areas due to long-term contracts; a seller may be unable to lock in margin based on expected raw material/feedstock costs and finished goods selling price; and a seller may be unable to predict cycle peaks and troughs.

Market inefficiencies, including the following, may also exist in short, long and normal markets for buyers: a buyer may experience difficulty in accessing a new or improved offering from new suppliers due to long-term contracts, which in turn are needed to secure supply in periods of short market conditions; quality buyers, those who pay on time, order on a regular basis and provide acceptable lead times, may be unable to access non-prime materials or be rewarded for their high level of transaction performance; a buyer may be unable to lock in margin based on expected plastic raw materials and finished goods selling price; and a buyer may be unable to determine changes in marketplace dynamics.

The inefficiency of the markets leads to a lack of transparent pricing which is one reason for which derivatives have been at significant or high premiums. In addition, the lack of market liquidity has made acquiring risk management instruments a lengthy process, which by definition, increases risk for a market-maker. In other words, for a market-maker to be willing to take on the risk associated with the position, that market-maker needs to sell the counter position rapidly in order not to extend themselves.

### SUMMARY OF THE INVENTION

The present invention provides methods and systems for conducting a liquid exchange in a discreet segment of a commodity goods market. An embodiment of the systems and methods of the present invention may be further utilized to create a derivatives market for the commodity goods. The embodiment may be implemented as a trading center where commodity products are substantially continuously offered for sale on a spot basis. The trading center may form the center of a community that includes, but is not limited to, commodity product suppliers, commodity product users, speculators and industry service providers. The community may exist on many levels and comprise an entire industry on one level and segments of that industry on other levels. The trading center may function as a market maker to facilitate the buying and selling of the commodity goods.

The trading center and community may be implemented as “virtual” centers, for example as a site on a computer network such as the World Wide Web; a corporate intranet; a government/military network or the like. Preferably, for ease of access to the widest number of participants, the virtual trading center is advantageously implemented as a site on the World Wide Web (Internet), and the buying/selling process is performed through the use of market-maker and financial systems software. Currently available hardware platforms, including PC's, Minicomputers and mainframes, and currently available operating systems, including UNIX, MS Windows, Mac OS and Linux, may be utilized to host the site.

The methods and systems of the present invention provide a solution to long felt industry needs in commodity markets. An advantage of the systems of the present invention is that the trading centers contemplated by the present invention provide increased liquidity for commodity goods. The trading center will provide a location for qualified buyers and sellers of commodity goods to congregate and consummate transactions. By providing a congregation point for buyers and sellers of commodities, the trading center facilitates finding sellers during times of high demand for commodities, and finding buyers during times of high supply of commodities. Liquidity of the commodities is also increased by the trading center providing a market-maker role that may include purchase of commodities during periods of oversupply and/or sale of commodities during periods of high demand.

As described above, a trading center may allow commodities to be bought and sold, for example on a spot basis, on a substantially continuous basis. The trading center may also provide further benefits such as lower transaction costs, access to consistent quality vendors and products, reliability of supply, lower required inventory positions, better cash management and long-term price stability through accurate business intelligence information. The trading center may also provide additional advantages to a commodity industry as detailed below.

The trading center may generate real-time performance metrics for suppliers and buyers in the industry. The trading center may also collect, collate and generate more accurate industry supply/demand information and trend information. The trading center may include databases of this type of information available to members of the community.

The trading center may also establish, provide and/or assist in the implementation of industry standards in areas including, but not limited to, complaint systems, terms and conditions of sale, payment, financing terms, shipping details, and the like.

The trading center may provide paper transactions, i.e. transactions where the buyer or seller may not be interested in the actual commodities being purchased, however the buyer or seller wishes to speculate in the market and mitigate the risk of market shortages or surpluses. This feature may advantageously increase liquidity of certain commodities.

An embodiment of the systems and methods of the current invention may further provide private trading rooms (PTR). A PTR will provide a transaction method for new or unproven buyers, sellers and products, unique products, pseudo-specialties, wide-spec and odd-lots. The PTR, through a private and controlled auction environment, will provide advantages to both buyers and sellers. The PTR will provide the buyer with a means to purchase difficult to describe, variable quality or unique goods from a predetermined number of vendors. The PTR will provide the seller with a method to sell off-class, small-market, difficult to describe or unique products. The PTR will provide further advantages of transaction efficiency and better inventory control, resulting in better cash management.

An embodiment of the systems and methods of the current invention may also provide exchange trading floors (ETF). The ETF is an open forum where any buyer and seller can initiate and consummate a transaction for any product. The ETF will provide transaction efficiency as well as a mechanism for gathering real-time market information.

An embodiment of the systems and methods of the current invention may also provide electronic store fronts (ESF) and processor preference centers (PPC). The ESF will provide an advertising and information forum for suppliers/sellers. The ESF may further provide the means for a supplier/seller to sell specific goods to specific sellers under seller-specific pricing rules. The PPC is analogous to the ESF but provided for the buyer. The PPC will allow the buyer to advertise new requirements and needs. The PPC may further include information such as credit rating and performance, market focus and other buyer-specific information. The ESF and PPC will increase market efficiency by providing much needed participant information to the market.

An embodiment of the systems and methods of the current invention may also provide a sample center (SC). The SC will provide a one-stop shop for the global logistics of all sample requests. The SC will provide advantages to both suppliers/sellers and buyers. The SC allows the supplier to eliminate the burden of expensive shipment of small quantities of product. The SC provides a single access point for buyers, improving transaction efficiency, information quality and decreasing the delivery time for samples. Further, in an embodiment of the present invention as a web site, the SC may increase the “stickiness” of the website due to quick turn-around of product shipments and customer neutrality.

An embodiment of the systems and methods of the current invention may further provide ancillary services to support the liquid marketplace. These services may include a global logistics support system to increase the efficiencies in transport of commodity goods. Other services may include a capacity exchange for product and capacity swaps, a futures contract market, professional development services, a plastics technology exchange, financial service offerings and significant industry data offerings. The services will help to increase the efficiencies of the market by providing a broad range of services and information to all participants in the market.

In order to fund the overhead costs of the virtual trading center, and to provide a return on investment to the party or parties that invest in forming the trading center, the trading center may charge a transaction fee, for example as a percentage of the deal price. As will be understood by those of ordinary skill in the art, members of the community, including buyers/sellers of commodities, as well as outside parties, may be investors in the trading center.

The methods and systems of the present invention, including the trading center and community advantageously reduce the market inefficiencies for suppliers, sellers and buyers. The systems and methods of the present invention offer value to community members and users of the trading center. As will be understood by participants in the commodity product industry, added value may be provided in a number of ways, including, but not limited to those listed below.

In short markets, the value may be added through: access to spot resin, reduced sourcing costs, reduced information inefficiency in product quality offered in long markets, and better assessment of true market conditions. In long markets, value may be added through: a clearer understanding of the quality of a product offering, an easier ability to spot buy, a better assessment of true market conditions, and an easier identification and procurement of new supply offerings.

The product trading centers of an embodiment of the present invention are designed to invite buyers and sellers to one location to conduct transactions and by definition, thus increase marketplace liquidity. An embodiment of the current invention may be advantageously implemented in the market for PET. This supply chain for this market is relatively less complex than that of other commodity plastics, and the various segments of PET are more easily describable than those of other commodity plastics.

The combination of liquidity plus transparent pricing information, which are fostered by the virtual trading centers, should reduce the premiums associated with derivative instruments. Further, in the commodity polymer industry, the volatility of commodity polymers is generally such that counter positions would be possible in a system of the present invention. For example, demand of PET is generally tied to variables that affect cost, including the weather and oil prices. Both the weather and oil prices currently have an established derivatives market, thus validating the fact that PET is volatile. The systems and methods of the present invention also provide transparent, up-to-date and truly dynamic pricing, therefore producing pricing information that will be credible and relevant and thereby decreasing the cost of risk management instruments.

Further features and advantages of the present invention are set forth below in the following detailed description.

### BRIEF DESCRIPTION OF THE FIGURES

These and other features, aspects, and advantages of the present invention are better understood when the following Detailed Description of the Invention is read with reference to the accompanying drawings, wherein:

FIG. 1 is a block diagram that provides an overview of the polymer commodity market segment supply chain, as it currently exists.

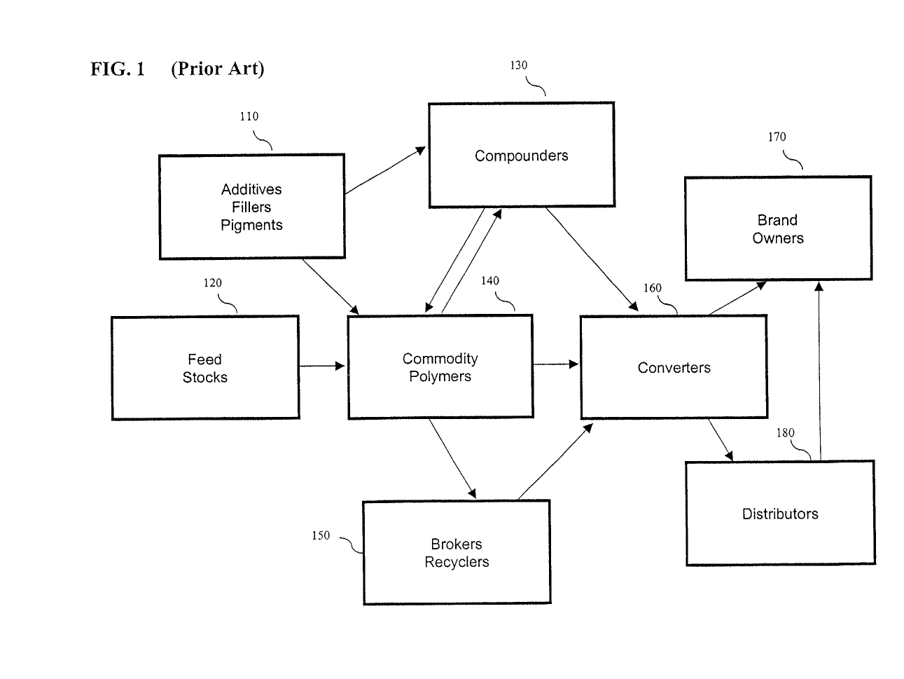

FIG. 2 is a block diagram that provides an overview of the polymer commodity market segment supply chain, as it exists under an embodiment of the current invention.

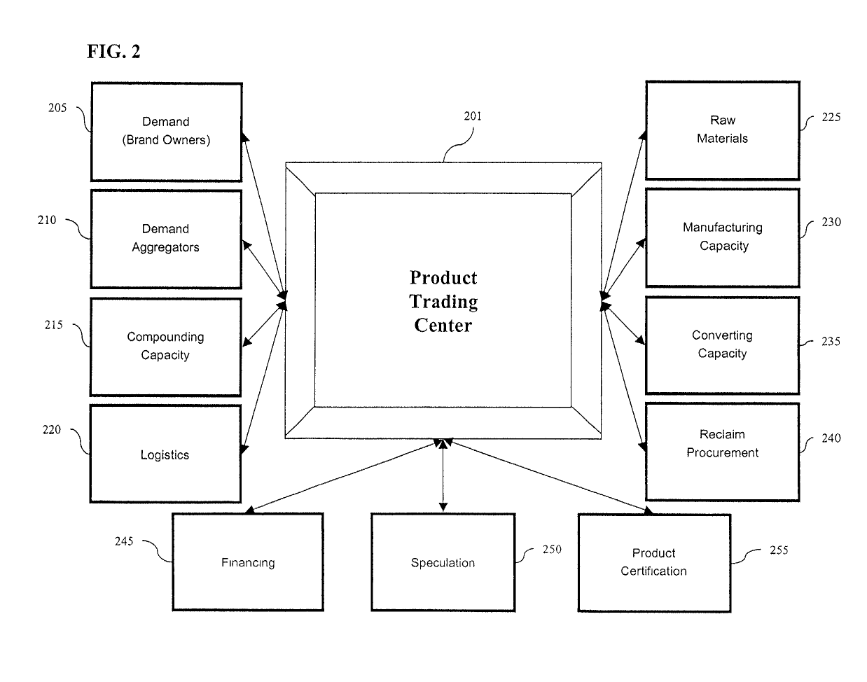

FIG. 3 shows an embodiment of a computer system in accordance with the present invention, including various network access devices and an application service provider.

FIG. 4 illustrates an embodiment of the steps a buyer or seller will take to consummate a transaction in a product trading center.

FIG. 5 illustrates an embodiment of steps in the process of choosing the correct transactional or informational area to which the participant should be directed.

### DETAILED DESCRIPTION OF THE INVENTION

The present invention provides methods and systems for conducting a liquid exchange in a discreet segment of a commodity goods market. An embodiment of the present invention may be a system comprising a plurality of market participants in the market segment, a network access device to which the participants have access, a computer network such as the World Wide Web, and an electronic product trading center, which can be accessed via the computer network.

The market segment may for example comprise a sub-segment of the commodity polymers segment of the plastics industry. The sub-segment may be the market for at least one of the following commodity polymers: low-density polyethylene (L.D.P.E.), linear low-density polyethylene (L.L.D.P.E.), high-density polyethylene (H.D.P.E.), polypropylene (P.P.), polystyrene (P.S.), acrylonitrile-styrene-butadiene (A.B.S.), and polyethylene terephtahalate (P.E.T.).

The market participants may comprise a purchaser and a seller. The market participants may further comprise at least one of: a feedstock producer; an additive producer; a commodity polymer producer; a compounder; a convertor; a broker; a recycler; a distributor; an end user; and a service provider.

In an embodiment of the system and methods of the current invention the forgoing market participants will access the virtual trading centers via a network access device. The network access device comprises at least one of: a telephone, a cellular-capable device, a personal digital assistant, and a computer. The virtual trading center may exist as a web site on the World Wide Web as well as other computer networks. The computer network may further comprise links to legacy systems within the market participants' networks.

An embodiment of the system and methods of the current invention may provide further features to increase the liquidity of the market by increasing transaction efficiency and allowing for better inventory control, resulting in better cash management. The system may further comprise an electronic private trading room. The system may also comprise and electronic exchange trading floor. Further, the system may comprise an electronic store front. The system may comprise an electronic processor preference center. The system may further comprise an electronic sample request and delivery center. The system may also comprise additional ancillary services. The services may comprise at least one of: a global logistics solutions support system; an electronic capacity exchange for product and capacity swaps; a professional development service; a financial service; and a comprehensive industry information service.

As an embodiment of the system and methods of the current invention increases the liquidity of the subject commodities market or segment of that market, the embodiment will increase the likelihood of supporting a derivatives market. In fact, an embodiment may further comprise a means to create a derivatives market accompanying the commodities market segment.

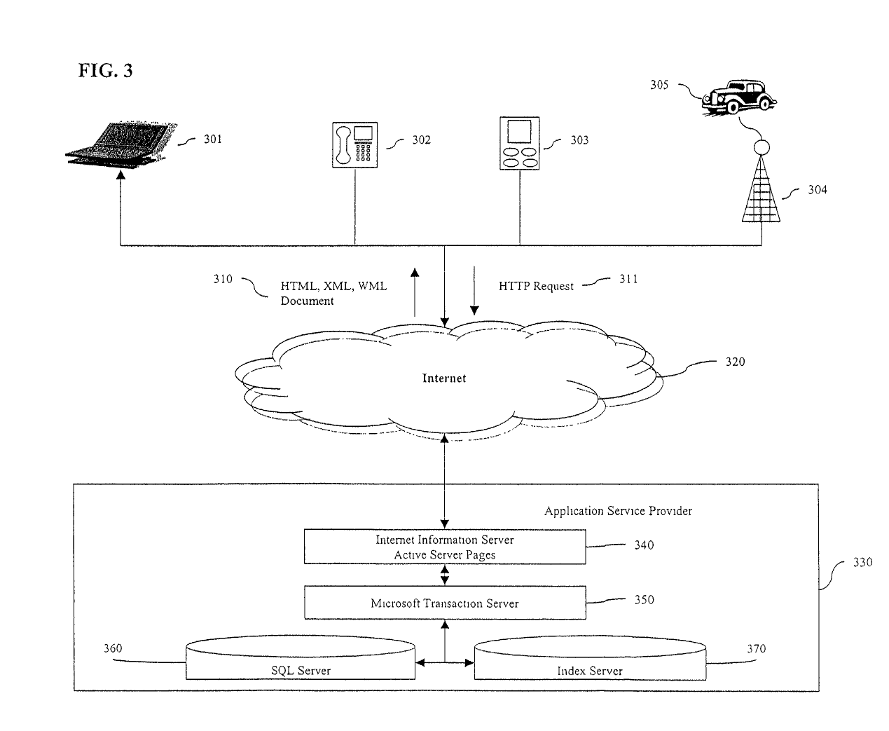

In an embodiment of the current invention, an electronic product trading center may comprise a database, an executant and a user interface. As one skilled in the art recognizes, the database, executant and user interface may be constructed in a number of ways. In one embodiment, an application service provider (ASP) will host virtual product trading center on a web server. Referring to FIG. 3, the market participant uses a network access devise 301-305 to access the Internet 320, issuing an HTTP request 311 for a specific uniform resource locator (URL). The network access device may be any one of, or any combination of, a computer 301, a telephone 302, a personal digital assistant 303 or a cellular device 305, which is routed through a cellular tower 304. The request is routed to the ASP 330, specifically to a web site, running under Microsoft Internet Information Server™ (IIS) 340, that the ASP has bound to the web site domain name. The user specifies may specify identification or other information through entry in a form and this information is posted, using a secure method such as secured sockets layer (SSL), to the web site.

When the web site receives the information, a web server-based environment such as java server pages or Microsoft Active Server Pages™ (MSASP) 340 receives the posted information. The MSASP instantiates an object running under an object request broker (ORB). Under one embodiment, the object that is instantiated conforms to the Common Object Modeling (COM) standard and is managed by Microsoft Transaction Server (MTS) 350, but one skilled in the art could also utilize objects conforming to Object Management Group's (OMG) Common Object Request Broker Architecture (CORBA) or other ORB and remote procedure call (RPC) architectures.

The object receives the request and uses processing rules to formulate a response. When the object that handles the specific user information that has been posted receives information from the MSASP, the object searches a database to confirm the retrieve the information required to satisfy the request. In one embodiment of the invention, Microsoft SQLServer 360 manages the database. In addition to providing the information residing in a relational database, the object may search additional databases as well as document repositories for information that is relevant to the identified industry(s) and market segment(s). In one embodiment of the invention, the document repository is managed by Microsoft Index Server (MSIS) 370.

The MSASP combines all the information retrieved from the various data sources into a document written using a markup language. The format of the document will be dependant on the network access device used by the market participant. Examples of markup languages are hypertext markup language (HTML), wireless markup language (WML) and extensible markup language (XML). In one embodiment, the response is created as an XML document and associated with a style sheet (XSL), producing a hypertext markup language (HTML) page for presentation to the user. The HTML page can contain excerpts from various articles and other sources of information as well as hyperlinks for access to the entire documents. The HTML page is then transmitted to the network access device 310.

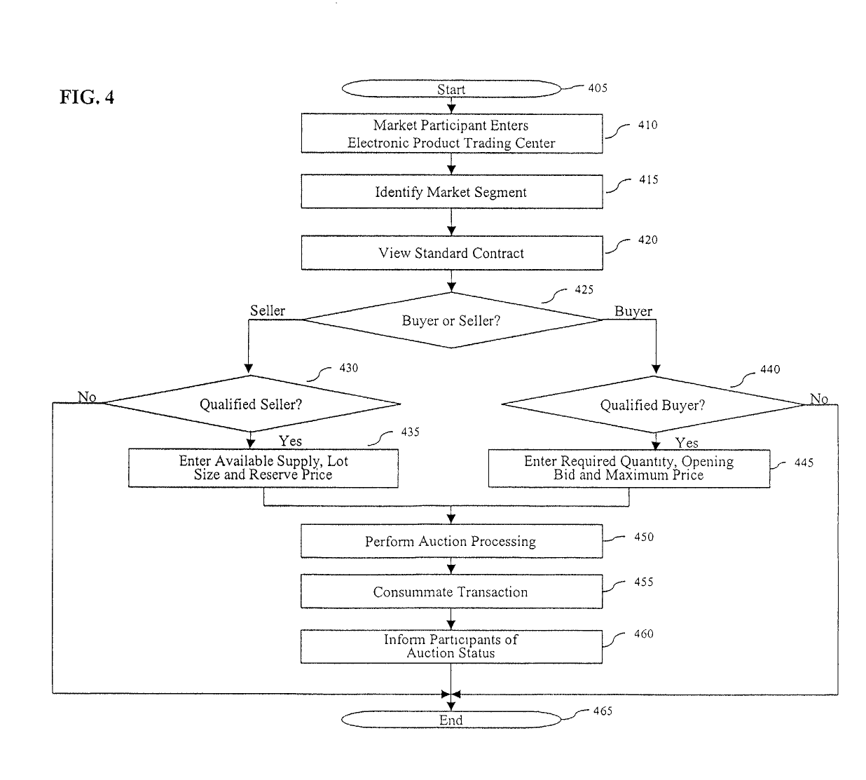

FIG. 4 illustrates an embodiment of the steps a buyer or seller will take to consummate a transaction in a product trading center (PTC). The participant begins the process 405 by entering the virtual product trading center 410. At this point, the participant identifies the market segment or sub-segment of interest to that participant 415. The standard contract is displayed and the participant may view it 420.

Next, the role of the participant in a particular transaction must be ascertained; the participant is either a buyer or a seller with regards to this specific transaction 425. If the participant is a seller, the PTC must check to see if that seller is qualified 430. If not, the process ends 465. If the seller is qualified, the seller can enter the available supply, the lot size, the reserve price, and any other relevant information 435.

A participant who is acting as a buyer with regards to a particular transaction must proceed through an analogous set of steps. First, the PTC must determine whether or not this participant is a qualified buyer 440. If not, as with the seller, the process ends 465. If the participant is a qualified buyer, then the buyer may enter the requested quantity, the opening bid and the maximum price that buyer is willing to pay 445.

At this point, the processes for sellers and buyers merge and the actual auction processing is performed 450. Once the auction processing has completed, the buyer and seller consummate their transaction 455 and all participants in the particular auction are informed of the results, including among other information the price, quantity and product grade 460. Informing all participants increases price transparency and helps to increase efficiency in the marketplace. Once all participants have been informed as to the results of the auction, the process ends 465.

To help provide liquidity in a commodity marketplace by decreasing inefficiency and increasing available information, an embodiment of the system and methods of the current invention may provide transaction facilities in addition to the virtual product trading centers. As mentioned above, these additional facilities may be provided in the form of one or more of the following: an electronic private trading room; an electronic exchange trading floor; an electronic store front; an electronic processor preference center; an electronic sample request and delivery center; and ancillary services.

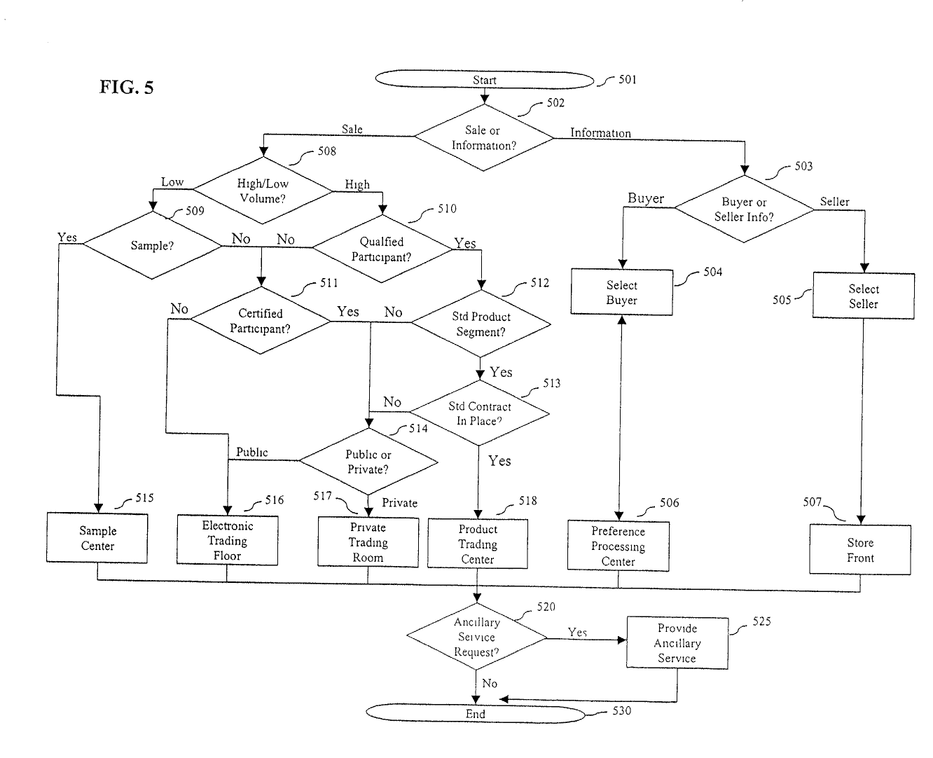

An embodiment of the current system may include one, many or even all of these additional facilities. As illustrated in FIG. 5, in an embodiment in which all of these facilities are provided, the market participants must choose or be directed to the particular facilities which best serves the participant's needs. FIG. 5 illustrates an embodiment of steps in the process of choosing the correct transactional or informational facility to which the participant should be directed. The first query posed is whether the participant is interested in consummating a sale or merely gathering information 502. In the case of an information search, the participant is must choose between buyer or seller information 503, and then the participant must choose the specific buyer/seller of interest 504, 505. If the participant chooses to view a specific buyer's information, the buyer's preference processing center (PPC) 506 is displayed. If the participant instead chooses a seller, the seller's electronic store front (ESF) is displayed 507. When the participant has finished viewing the PPC or analogous ESF, then the user is asked whether or not they wish to take advantage of an ancillary service 520. The query of whether or not to take advantage of ancillary services is presented to a participant after any of the various sales and information elements of the present embodiment are presented. These services may include, but are not limited to, a global logistics solutions support system, an electronic capacity exchange for product and capacity swaps, a professional development service, a financial service, and a comprehensive industry information service. If the participant chooses an ancillary service, that service is provided 525. If the participant chooses to forgo the ancillary services, or after the services are provided, the process ends 530.

Again referring to FIG. 5, if the participant responds “sale” to the initial query, then the type of sale and the participant's status must be determined. First the participant must specify whether the sale is a high or low volume sale 508. If it is a low volume sale, the participant must further specify whether the sale concerns a sample or not 509. If the sale is a sale of a sample, the participant is directed to the sample center 515. Once again, ancillary services may or may not be requested 520 and provided 525, and the process ends 530.

If the participant specifies a low volume sale 508 that is not related to a sample 509, then the system must determine whether the participant is a “certified” seller/buyer or not 511. If not, the participant is directed to the electronic trading floor 516. If the participant is certified, then the participant may choose a public or private sale 514. If the participant chooses a public sale, they are directed to the electronic trading floor 516. Alternatively, if they request a private sale, they are directed to a private trading room 517.

Once again referring to FIG. 5, if a participant select a high volume sale instead of a low volume sale 508, then the embodiment must determine whether or not the participant is a “qualified” buyer/seller 510. If the participant is not qualified, then the process proceeds as in a low-volume, non-sample sale 511, 514, 516 and 517. If the participant is qualified, then the embodiment must determine whether the product segment of interest to the participant is a standard product segment 512. If not, then the participant may choose a public or private sale 514 in the electronic trading floor 515 or private trading room 517 respectively. If it is a standard product, then the embodiment must determine the existence of a standard contract 513. If a standard contract is in place, then the participant is directed to the product trading center 518. If a standard contract is not in place, then once again, the participant may choose a public or private sale 514 in the electronic trading floor 515 or private trading room 517 respectively.

As discussed above, the systems and methods of the present invention may be utilized to create derivative markets for commodity goods. The following terminology may be utilized in describing derivative markets created utilizing the systems and methods of the present invention.

Liquidity: The ease, speed and convenience with which a commodity can be converted into the medium of exchange (money) with minimal loss of capital. In the United States, US Dollars are the most liquid asset. Other assets which are considered liquid, generally in order of decreasing liquidity, include treasury bills (T Bills), blue chip securities, “A” rated debt securities, small cap securities, junk bonds, etc. Liquidity applies to physical goods as well, with more “liquid” goods being more easily converted into money that less liquid goods.

Transparent Price: A price point that is current and visible to all interested parties such as buyers, sellers and speculators.

Basis: A basis is an industry standard contract, that is a contract for a specific grade of product within a commodity category, with a specific price, method of delivery, unit of measurement, total volume, shipping point, and other. The basis is, by definition transparent and available to any interested party with special conditions associated to futures and forwards as listed below. As an example, there exist many different types of oil such as Sweet Texas Crude Oil, Alberta Crude, Saudi Arabian Crude, etc. The basis for crude oil is West Texas Intermediate Crude Oil, delivered in Kushing, Okla., for a given price at a given time per barrel.

The purpose of establishing a basis is to set the base or reference price of a widely accepted product category within a commodity. In fragmented but yet liquid commodities such as oil, corn, fertiliser, soybeans, orange juice, cocoa, where there are a variety of grades within the commodity category, the basis increases liquidity and can help establish risk management instruments.

Specifically, the formula for the basis price is the following:

Basis price=Cash price−Futures price

Basis Risk: Parties may take a position in the basis even if they do not have a physical interest in taking possession of the goods. In this sense, the basis is a derivative instrument that is used to hedge the risk of price volatility for the items of interest. The implied risk in differences in price movements is called Basis Risk. In this sense, the market sets the price for the basis and other specific products within that commodity are traded at a differential from the basis. The market also independently sets the price differential between the basis price and the specific product category price. This differential price can change over time for a variety of reasons such as anomalies in supply/demand, product maturity, or other.

In highly evolved markets, the basis acts as the surrogate for the cash price and the cash price becomes the derivative of the basis. In this sense, the cash price is calculated by taking the Basis Price+Futures Price.

Contract Price: Price established for goods to be delivered in the minimum amount of time that physical delivery will take place. If normal delivery takes 15 days, the contract price is the price set for any delivery that will take place in that point of time. Cash settlement takes place at this time the goods are delivered. In liquid markets, the contract price is the price stated in the basis contract.

Spot Price: The price of a given commodity at a given instant second. Cash settlement takes place immediately.

Forward: A standard basis contract or a one-off and non-standard contract written between two parties for delivery of physical goods at a point in time no shorter than the minimum delivery time. A forward can involve a cash or product settlement from both parties. Forwards are not regulated instruments. Forward contracts can be bought and sold by both parties with the caveat that the other party has the ability to accept or reject the transfer or sale of the contract to only those parties that they approve. Most forwards are transacted with physical settlement despite provision for cash settlement.

Future: A future is a forward contract that can be transferred or sold to a third party without approval by the counter party. For this reason, the Commodity Futures Trading Commission (CFTC) regulates futures. In addition and in accordance with the CFTC regulations, owners of futures must have an offsetting amount of cash in a reserve account. The amount of cash is adjusted on a daily basis in accordance with market conditions of the day. Futures are therefore valued at the priced daily and assumed to be equivalent to cash assets. This has implications as to the tax laws in that these assets have gains/losses that are imputed daily. Forwards on the other hand, have gains/losses once the contract is fully consumed by both parties. This difference is called Mark To Market. Most futures are transacted with cash settlement despite provisions for physical settlement.

1862: The first standardized set of contracts written the Chicago Board of Trade (CBOT). The CBOT started these futures for oats. Due to the war the demand to feed horses and therefore oats increased dramatically. The CBOT determined that it had written more contracts to buy oats than estimated could ever be produced. Therefore, it was a governing authority by which contracts for future delivery were standardized, written, and could be bought and sold by either party, where both physical settlement and cash settlement could take place. This prevented the collapse of the oats market.

Over-the-counter (OTC): An unregulated network of traders that communicate and conduct business via the telephone. By definition, no futures are traded OTC.

Spread Instrument: In fragmented and liquid commodities where standardized forwards or futures are written, a synthetic instrument called a spread is established to minimize the basis risk associated with the particular commodity of interest. Spreads are both standardized and non-standardized synthetic instruments that help optimize mitigate all basis risk. As an example, the CRACK spread is 3 crude oil contracts are offset by 2 gasoline contracts and 1 heating oil contract.

Spreads, by definition increase the number of opposing view, counter positions and therefore liquidity.

Spreads can be established on custom or standard forwards and futures. As an illustrative example only, one may find, through analysis, a correlation between the prices of PET, oil, cotton and weather trends. If this were the case, a PET spread could be created. By doing so, a number of opposing views would take place from the oil industry, the cotton industry and the general industry because of weather. All participants in the other industries may take positions to optimize to their specific risk profile.

Synthetic Instrument: A series of standardized or custom spreads assembled together to optimize the correlation or counter-correlation in pricing with the specific commodity of interest.

Speculation: Qualified parties that have no interest in physical settlement but that could provide physical settlement if needed.

Arbitrage: An identified anomaly in prices that provides an opportunity to a disproportionate return. Shell, Koch Industries, Dreyfus and Enron could be called arbitrageurs because they are in the business of making money in non-transparent markets.

Derivative: Any type of risk management instrument.

As described in detail herein, the systems and methods of the present invention may be utilized to create derivative markets in a commodity marketplace. Preferably the commodity marketplace will include one or more of the following features: many buyers and sellers, preferably at least 50-100 buyers and sellers. For example, the highly successful silver pit commodity marketplace sometimes has as little as 8 buyers/sellers/speculators but sometimes as many as 50; no single buyer or seller controls the market. If the market is cornered, there are fewer opposing views; a standard contract. A basis contract that is widely accepted and understood by all parties; uncertainty in supply; uncertainty in demand helps increase volatility and therefore the need for risk management instruments; and the industry participants should have a collective mindset where risk mitigation is desirable.

An example of a successful commodity market is the market for orange juice. The market includes thousands of producers and many buyers. Therefore, there are naturally differing views. In addition, the market is highly volatile because of changes in the weather and other factors, which affect both yield and quality, and therefore supply at any given time uncertain. Further, no single producer controls the market and all participants seek risk mitigation dearly.

An embodiment of the methods and systems of the present invention may be utilized to create a commodity market and/or an accompanying derivatives market for polyethylene terephthalate (PET). In this embodiment, the commodity market preferably includes a sufficient number of suppliers and users for risk mitigation. In a preferred embodiment, the PET commodity marketplace of the present invention would include participation by at least 10, preferably 15-20 or more, PET suppliers; and at least 10, preferably 15-30 or more, users of PET. As will be understood by those of ordinary skill in the art, the actual number of suppliers and users is not fixed and can vary, depending, in part, on the tolerance for risk by market participants.

In this embodiment of the present invention, a standard contract or basis is established or adopted. The standard contract or basis is sufficiently understood by all participants in the market to enable them to participate.

A standard product for PET would also be established and agreed upon by the industry. This could be water grade, a particular IV or other product descriptor, chip grade, or any other grade that is generally accepted as a “standard” product.

The embodiment may also include a standard synthetic instrument (for example a PET SPREAD) based on the correlation and inter-relationship, if any, among PET and other commodities, or factors, e.g. oil, cotton, the weather. The PET SPREAD would help increase the number of views by allowing the marketplace to include speculators of the commodity (PET). Popular belief is that the premiums offered are high because these arbitrageurs do not want business from large producers who in themselves, operate as market makers/speculators in today's environment. They rather take advantage of information inefficiencies with smaller buyers/sellers that do not have the more in-depth understanding of market dynamics and trends. Market concentration could actually be beneficial as earnings are more carefully scrutinized, even for private companies given the highly capital intensive nature of the industry. In this case, a PET SPREAD would increase the number of opposing views as discussed previously.

In this embodiment of the present invention, a PET “pit” or virtual PET pit, would be developed using a basis contract in the form of a forward (preferably not future due to tax implications) where the marketplace acts as the police for accredited buyers and sellers thus increasing the propensity for buying/selling of contracts. The standard synthetic instrument that would be created (a PET SPREAD) would assist in increasing the amount of opposing views, increase the number of buyers and sellers, increase the frequency of transactions and thus increase liquidity. Producers and users would mitigate the upside and downside in price swings and decouple risk from product value. Competition would take place in the areas of cost of goods including freight, product differentiation and technology.

The systems and methods of the present invention utilizing a virtual trading center, have a positive impact on the ability to create risk mitigation instruments given the dramatically lower cost of operating a virtual pit versus the traditional pit, the ability for even the smallest of buyers to have access to a pit at no or minimal cost and the new market-centric business models.

The foregoing description of the preferred embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention. As will be understood from the whole of the description set forth herein, the concepts, systems and/or methods of the present invention may be utilized in other industries, and with and for other commodity products.

That which is claimed:

1. A system for conducting a liquid exchange in a discreet segment of a commodity goods market comprising:
a plurality of market participants in said market segment;
a network access device accessible to said market participants;
a computer network connected to said network access device; and
an electronic product trading center connected to said computer network.

2. A system as in claim 1, wherein said market segment comprises a sub-segment of the commodity polymers segment of the plastics industry.

3. A system as in claim 2, wherein said sub-segment comprises at least one of:
a low-density polyethylene (L.D.P.E.) sub-segment;
a linear low-density polyethylene (L.L.D.P.E.) sub-segment;
a high-density polyethylene (H.D.P.E.) sub-segment;
a polypropylene (P.P.) sub-segment;
a polystyrene (P.S.) sub-segment;
an acrylonitrile-styrene-butadiene (A.B.S.) sub-segment; and
a polyethylene terephtahalate (P.E.T.) sub-segment.

4. A system as in claim 1, wherein said plurality of market participants comprises:
a purchaser; and
a seller.

5. A system as in claim 4, wherein said plurality of market participants further comprises at least one of:
a feedstock producer;
an additive producer;
a commodity polymer producer;
a compounder;
a convertor;
a broker;
a recycler;
a distributor;
an end user; and
a service provider.

6. A system as in claim 1, wherein said network access device comprises at least one of:
a telephone;
a cellular-capable device;
a personal digital assistant; and
a computer.

7. A system as in claim 1, wherein said computer network comprises the world-wide web (Internet).

8. A system as in claim 1, wherein said electronic product trading center comprises:
a database;
an executant connected to said database; and
a user interface connected to said executant.

9. A system as in claim 8, wherein said database comprises a Microsoft® SQLServer database.

10. A system as in claim 8, wherein said database comprises a document repository.

11. A system as in claim 10, wherein said document repository comprises a Microsoft® Index Server document repository.

12. A system as in claim 8, wherein said executant comprises at least one of:
a Microsoft® Active Server Pages (ASP) program;
a java server pages (JSP) program; and
a compiled program executing under the control of an object request brokering application.

13. A system as in claim 8, wherein said user interface comprises a document created using a document markup language.

14. A system as in claim 1, further comprising an electronic private trading room.

15. A system as in claim 1, further comprising an electronic exchange trading floor.

16. A system as in claim 1, further comprising an electronic store front.

17. A system as in claim 1, further comprising an electronic processor preference center.

18. A system as in claim 1, further comprising an electronic sample request and delivery center.

19. A system as in claim 1, further comprising ancillary services, said ancillary services comprising at least one of:
a global logistics solutions support system;
an electronic capacity exchange for product and capacity swaps;
a professional development service;
a financial service; and
a comprehensive industry information service.

20. A system as in claim 1, further comprising a means to create a derivatives market accompanying said commodities market.

21. A process for conducting a liquid exchange between a plurality of participants in a discreet segment of a commodity goods market comprising:
identifying a standard product in said segment;
creating a standard contract for said liquid exchange of said standard product; and
consummating said exchange between said participants.

22. A process as in claim 21, wherein said market segment comprises a sub-segment of the commodity polymers segment of the plastics industry.

23. A process as in claim 22, wherein said sub-segment comprises at least one of:
a low-density polyethylene (L.D.P.E.) sub-segment;
a linear low-density polyethylene (L.L.D.P.E.) sub-segment;
a high-density polyethylene (H.D.P.E.) sub-segment;
a polypropylene (P.P.) sub-segment;
a polystyrene (P.S.) sub-segment;
an acrylonitrile-styrene-butadiene (A.B.S.) sub-segment; and
a polyethylene terephtahalate (P.E.T.) sub-segment.

24. A process as in claim 21, wherein said plurality of market participants comprises:
a purchaser; and
a seller.

25. A system as in claim 24, wherein said plurality of market participants further comprises at least one of:
a feedstock producer;
an additive producer;
a commodity polymer producer;
a compounder;
a convertor;
a broker;
a recycler;
a distributor;
an end user; and
a service provider.

26. A process as in claim 21, further comprising conducting an exchange in an electronic private trading room.

27. A process as in claim 21, further comprising conducting an exchange on electronic exchange trading floor.

28. A process as in claim 21, further comprising conducting an exchange in an electronic store front.

29. A process as in claim 21, further comprising collecting a preference from said participants in an electronic processor preference center.

30. A process as in claim 21, further comprising the steps of:
receiving a request for a sample in an electronic sample request and delivery center (SRDC);
in response to said request, processing said request; and
at the conclusion of said processing, shipping said sample.

31. A process as in claim 21, further comprising providing ancillary services, said ancillary services comprising at least one of:
a global logistics solutions support system;
an electronic capacity exchange for product and capacity swaps;
a professional development service;
a financial service; and
a comprehensive industry information service.

32. A process as in claim 21, wherein said standard contract is a forward contract.

33. A process as in claim 21, further comprising creating a derivatives market accompanying said commodities market.

34. A process as in claim 33, wherein creating said derivatives market comprises creating a standard synthetic instrument.
